(19) United States
(12) Patent Application Publication
(10) Pub. No.: US 2024/0342981 A1
(43) Pub. Date: Oct. 17, 2024

(54) MULTILAYER MULTIPHASE PRINTING WITH STIMULI-RESPONSIVE POLYMERS

(71) Applicants: Kenan Song, Athens, GA (US); Dharneedar Ravichandran, Tempe, AZ (US); Yuxiang Zhu, Gilbert, AZ (US)

(72) Inventors: Kenan Song, Athens, GA (US); Dharneedar Ravichandran, Tempe, AZ (US); Yuxiang Zhu, Gilbert, AZ (US)

(21) Appl. No.: 18/633,255

(22) Filed: Apr. 11, 2024

Related U.S. Application Data
(60) Provisional application No. 63/496,178, filed on Apr. 14, 2023.

(51) Int. Cl. B29C 64/118; B29C 64/194; B29K 67/00; B29K 75/00; B29K 105/16; B29K 505/12; B33Y 40/10; B33Y 70/10; B33Y 80/00

(52) U.S. Cl. CPC B29C 64/118; B29C 64/194; B33Y 40/10; B33Y 70/10; B33Y 80/00; B29K 2067/04; B29K 2075/00; B29K 2105/162; B29K 2505/12; B29K 2995/0008

(57) ABSTRACT

Fabricating a stimuli-responsive object includes providing a first feedstock and a second feedstock to a print head, extruding a multi-sublayer extrudate from the print head, depositing the multi-sublayer extrudate on a substrate to yield an extrudate layer, and curing the extrudate layer to yield the stimuli-responsive object. A first feedstock, a second feedstock, or both includes one or more stimuli-responsive polymer composites, and the print head includes n multipliers. A multi-sublayer extrudate includes 2⁽ⁿ⁺¹⁾/2 sublayers of a first feedstock and 2⁽ⁿ⁺¹⁾/2 sublayers of a second feedstock, and 2⁽ⁿ⁺¹⁾/2−1 sublayers of a first feedstock are in direct contact with two sublayers of a second feedstock. A stimuli-responsive polymer composite includes thermally actuated polymers. A stimuli-responsive polymer composite includes thermoplastic polymers. A stimuli-responsive polymer composite includes magnetic material. A magnetic material includes iron oxide nanoparticles.

### CROSS-REFERENCE TO RELATED APPLICATION

This application claims the benefit of U.S. Patent Application 63/496,178 filed on Apr. 14, 2023, which is incorporated herein by reference in its entirety.

### STATEMENT OF GOVERNMENT SUPPORT

This invention was made with government support under grant number 2145895 awarded by the National Science Foundation. The government has certain rights in the invention.

### TECHNICAL FIELD

This invention relates to additive manufacturing (3D printing) methods used to fabricate multilayered and multiphased stimuli-responsive structures.

### BACKGROUND

Polymers with stimuli-responsiveness (e.g., smart polymers) can demonstrate altered physical properties, chemical properties, or both upon exposure to specific environmental conditions. As a result, these materials have broad applications in sensors, actuators, soft robotics, coatings, environmental remediation, targeted drug delivery, and tissue engineering. Among these smart polymers, shape memory polymers (SMPs) have attracted attention due at least in part to advantages in lightweight, mechanical robustness (e.g., extensive strain recovery), thermal manipulability (e.g., a range of glass transition temperatures), electrical insulation, chemical stability (e.g., corrosion resistance), biocompatibility, and low-cost processability.

Additive manufacturing (3D printing) is an effective technique for rapid prototyping and customized design. For example, 3D printing can deposit materials at user-defined positions and allow dimensional variation to provide desirable actuation control of complex geometries. In addition, different printing mechanisms can include multi-materials at different scales.

### SUMMARY

This disclosure describes an additive manufacturing process for printing multilayered polymer composites including stimuli-responsiveness. The process uses a uniquely designed print head for additive manufacturing that is configured to transform two feedstocks into a multilayered extrudate with alternating layers of the two feedstocks within each printing line. Structures are formed with hierarchical in-plane and out-of-plane feedstock layers. One or both of the feedstocks can be multi-materials that can be actuated by environmental stimuli (e.g., temperature, pressure, electrical field, and magnetic field). Examples of these multi-materials include polyether- and polyester-based thermoplastic polyurethane (TPU) elastomers for reversible shape morphing; polycaprolactone (PCL) for thermal actuation; and (iii) iron oxide (Fe₃O₄) for magnetic manipulations.

In a first general aspect, a method of fabricating a stimuli-responsive object includes providing a first feedstock and a second feedstock to a print head, extruding a multi-sublayer extrudate from the print head, depositing the multi-sublayer extrudate on a substrate to yield an extrudate layer, and curing the extrudate layer to yield the stimuli-responsive object. The first feedstock, the second feedstock, or both include one or more stimuli-responsive polymer composites, and the print head can include n multipliers. The multi-sublayer extrudate includes 2⁽ⁿ⁺¹⁾/2 sublayers of the first feedstock and 2⁽ⁿ⁺¹⁾/2 sublayers of the second feedstock, and 2⁽ⁿ⁺¹⁾/2−1 sublayers of the first feedstock are in direct contact with two sublayers of the second feedstock. Implementations of the first general aspect can include one or more of the following features.

The multi-sublayer extrudate can include 2⁽ⁿ⁺¹⁾ sublayers. Curing the extrudate layer can include a cured extrudate layer, and can further include depositing an additional extrudate layer on the cured extrudate layer. In some implementations, the additional extrudate layer can include 2⁽ⁿ⁺1) sublayers aligned in a direction transverse to 2⁽ⁿ⁺1) sublayers of the extrudate layer. The one or more stimuli-responsive polymer composites can include thermally actuated polymers. In some implementations, the thermally actuated polymers can include polycaprolactone. The one or more stimuli-responsive polymer composites can include thermoplastic polymers. In some implementations, the thermoplastic polymers can include thermoplastic polyurethane. The one or more stimuli-responsive polymer composites can include magnetic material. The magnetic material can include iron oxide nanoparticles. Curing the extrudate layer can include irradiating the extrudate layer with ultraviolet radiation.

In another general aspect, a stimuli-responsive structure includes two or more sublayers of a first stimuli-responsive polymer composite and two or more sublayers of second stimuli-responsive polymer composite, and one or more layers including the two or more sublayers of the first stimuli-responsive polymer composite and the two or more sublayers of the second stimuli-responsive polymer composite. Each sublayer of the first stimuli-responsive polymer composite is in direct contact with at least one sublayer of the second stimuli-responsive polymer composite. Implementations of the first general aspect can include one or more of the following features.

The first stimuli-responsive polymer composite, the second stimuli-responsive polymer composite, or both can include thermally actuated polymers. In some aspects, the thermally actuated polymers can include polycaprolactone. The first stimuli-responsive polymer composite, the second stimuli-responsive polymer composite, or both can include thermoplastic polymers. The thermoplastic polymers can include thermoplastic polyurethane. The first stimuli-responsive polymer composite, the second stimuli-responsive polymer composite, or both can include magnetic material. In some implementations, the magnetic material can include iron oxide nanoparticles.

The one-step deposition of multiple alternating layers of feedstock from a single print head helps to prevent phase mismatches, interfacial debonding, and pore generations in general extrusion-based 3D printing. The technique can deposit thin layers of alternating feedstock material with precision and with rapid printing speeds. The properties of the printed stimuli-responsive object can be influenced by the number and thickness of the alternating layers of feedstock produced by the additive manufacturing print head.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 depicts a system for in-line and out-of-plane layered additive manufacturing (3D printing) for multi-material printing.

FIG. 2 depicts a print head of a system for in-line and out-of-plane layered additive manufacturing (3D printing) for multi-material printing.

FIG. 3 depicts the in-line and out-of-plane layered additive manufacturing (3D) printing technique for a single out-of-plane (z-axis) printing layer.

FIG. 4 depicts the in-line and out-of-plane layered additive manufacturing technique for two out-of-plane (z-axis) printing layers.

### DETAILED DESCRIPTION

This disclosure describes a multiphase direct ink writing additive manufacturing (e.g., 3D printing) technique to print in-line and out-of-plane layered structures including stimuli-responsive polymers advantageous for control by means of external environmental factors. As used herein, “stimuli-responsive polymer” generally refers to a polymer that can reverse back to an original shape from a deformed shape through physical or chemical changes under external stimuli including but not limited to temperature, chemical solutions, saline solutions, electric fields, magnetic fields, and light, such that the physical or chemical changes of the polymer can be used to execute a reproducible process. The additive manufacturing printer uses a unique print head designed to take multi-materials (e.g., gels containing different polymers and nanoparticles) as feedstocks before rearranging the multi-materials alternatively in one or more layer multipliers, forming sublayers within each printing line and enabling hierarchical in-plane and out-of-plane layers. These multi-materials include (i) polyether- and polyester-based thermoplastic polyurethane (TPU) elastomers for reversible shape morphing, (ii) polycaprolactone (PCL) for thermal actuation, and (iii) iron oxide (Fe₃O₄) for magnetic manipulations. In addition, the layer numbers can influence the thermal transition and actuation of the polymer composites, demonstrating effectiveness in expanding rolled structures with different heating temperatures, printing textures, and moisture degrees.

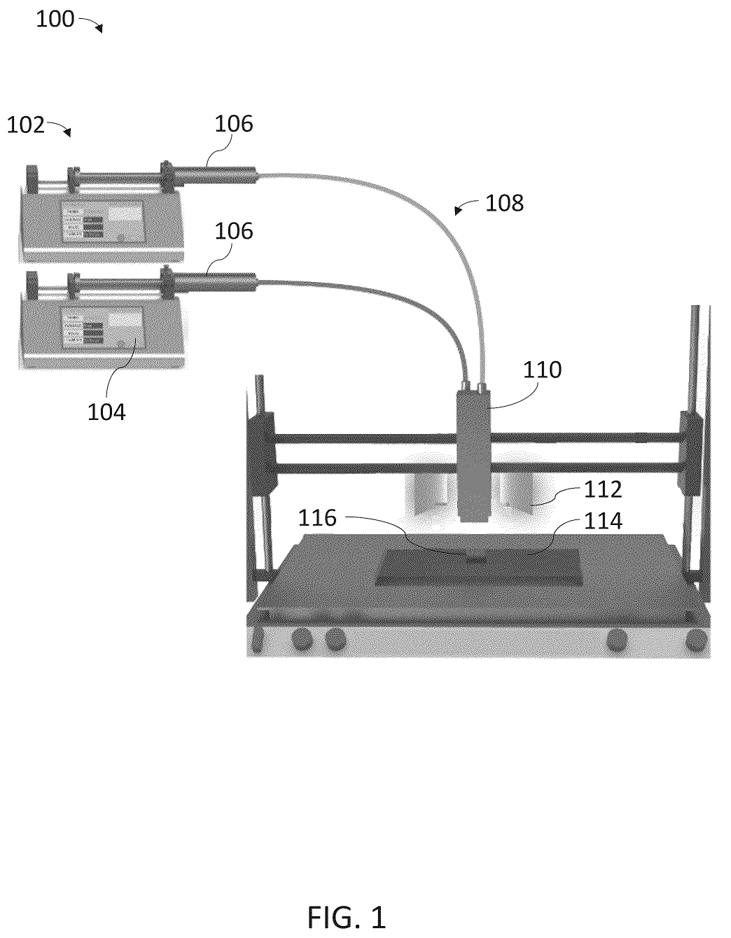

FIG. 1 depicts system 100 for in-line and out-of-plane layered additive manufacturing (3D printing) for multi-material printing. System 100 includes injection controls 102 for material feedstock (e.g., a first feedstock and a second feedstock). The material feedstock typically includes one or more stimuli-responsive polymer composites. Injection controls 102, including one or more programming/machine controls/processors 104 configured to control a printing path, structural design and injection of a material feedstock, are operatively coupled to syringes 106 for delivering material feedstock through conduits 108 to print head 110. Ultraviolet (UV) source(s) 112 are positioned proximate print head 110. Print head 110 is configured to dispose material feedstock on substrate 114 to form stimuli-responsive printed objects 116.

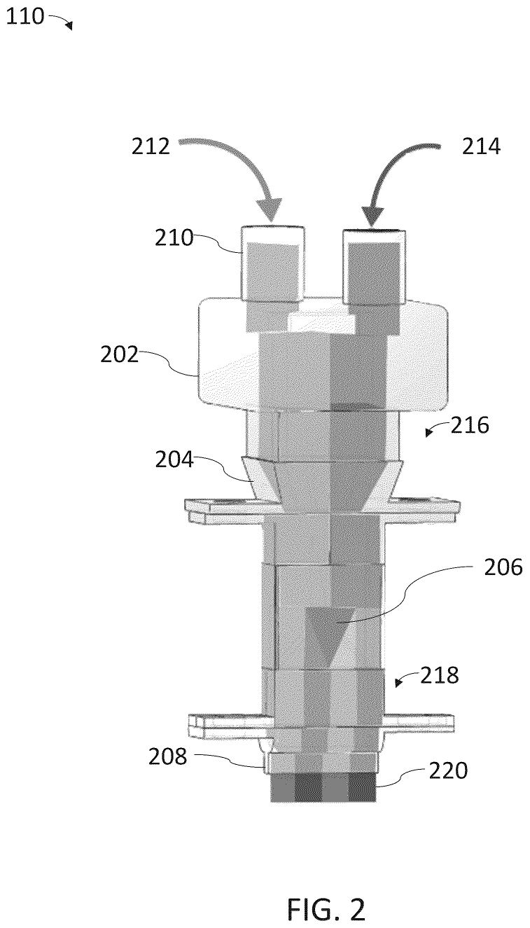

FIG. 2 depicts print head 110 of system 100. FIG. 2 illustrates the components of the print head 110 including spinneret 202, minimizer 204, layer multiplier 206, and reducer 208. Print head 110 includes separate channels 210 defined by the spinneret 202. The first feedstock 212 and the second feedstock 214 are delivered to the separate channels 210 and are disposed into two-sublayer extrudate 216. The minimizer 204 is positioned proximate to the spinneret 202 and is configured to reduce the flow area of two-sublayer extrudate 216. Layer multiplier 206 is positioned proximate to the minimizer 204 and is configured to transform two-sublayer extrudate 216 into multi-sublayer extrudate 218. In the example shown in FIG. 2, layer multiplier 206 divides a first feedstock 212 and a second feedstock 214 before rearranging first feedstock 212 and second feedstock 214 from two to four sublayers. A number of coupled n layer multipliers 206 will generate 2ⁿ⁺¹ sublayers within each printing line. In one example, the use of five layer multipliers 206 generated 64 sublayers within a 10 mm-wide printing line, leading to an in-line domain size of ˜100 μm. Using up to 64 sublayers promotes reduced interlayer dispersion of Fe₃O₄ nanoparticles and contributes to uniform layer formation. Rheology matching between a first feedstock 212 and a second feedstock 214 may reduce layer disruptions. Fluid flow simulations indicate that layer formation has fewer disruptions between fluids with similar viscosity, while different flow behaviors lead to layer disruptions. Improving printing resolution from the microscale to the nanoscale can be accomplished with a larger number of layer multipliers 206.

A multi-sublayer extrudate 218 includes alternating sublayers of a first feedstock 212 and a second feedstock 214. A reducer 208 is positioned proximate to the layer multiplier 206. Reducer 208 is configured to receive multi-sublayer extrudate 218 from layer multiplier 206. Reducer 208 is configured to modify the dimensions of multi-sublayer extrudate 218 in a plane transverse to the flow direction of multi-sublayer extrudate 218. Multi-sublayer extrudate 218 in FIG. 2 is depicted as a four-sublayer extrudate 220.

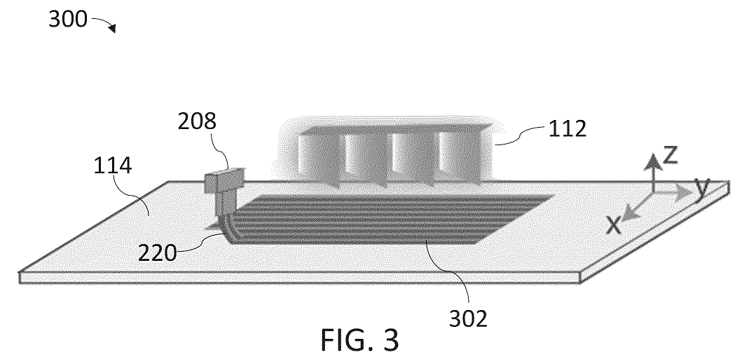

Print head 110 depicted in FIG. 2 can be configured with multiple layer multipliers 206. Each layer multiplier 206 doubles the number of entering feedstock layers. The total number of layers in the multi-sublayer extrudate 218 that exits a print head 110 fitted with n layer multipliers is 2⁽ⁿ⁺¹⁾. In the example depicted in FIG. 2 and FIG. 3, the print head is configured with a one-layer multiplier and deposits 4-sublayers with each printing line.

FIG. 3 depicts an in-line and out-of-plane layered additive manufacturing (3D) printing technique for a single out-of-plane (z-axis) printing layer. The 4-sublayer extrudate 220 exits the reducer 208 and is deposited on a substrate 114 to yield a printing line 302 including 4 alternating in-plane sublayers of a first feedstock 212 and a second feedstock 214. As used herein, “sublayer” refers to a layer of a feedstock in the alternating multi-sublayer extrudate 218 after deposition by the print head 110. The print head 110 moves along the in-plane y-direction while depositing each 4-sublayer printing line 302. When the desired length of 4-sublayer printing line 302 is attained, deposition of the extrudate pauses, print head 110 moves a distance equal to the width of a 4-sublayer printing line in the in-plane x-direction, and print head 110 deposits another 4-sublayer printing line 302 proximate to the previously deposited line. Printing continues until the desired dimension of the printed area is attained in the x-direction. For the examples depicted in FIGS. 1-4, one or both of a first feedstock 212 and a second feedstock 214 is cured with ultraviolet (UV) radiation after deposition on the substrate 114. Curing is provided by one or more UV source(s) 112 irradiating a 4-sublayer extrudate 220 printing line 302 as the four-sublayer extrudate 220 is deposited on substrate 114 by print head 110.

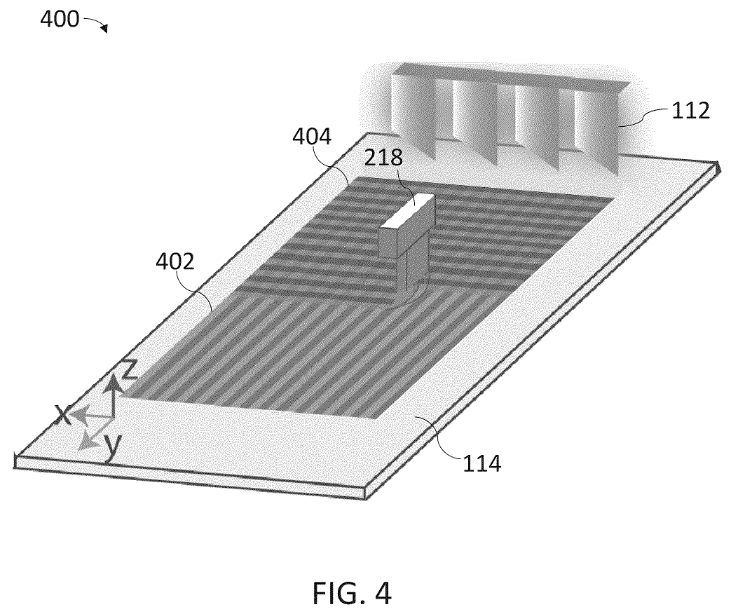

FIG. 4 depicts an in-line and out-of-plane layered additive manufacturing technique for two out-of-plane (z-axis) printing layers. First out-of-plane layer 402 is printed with print head 110 moving in the y-direction while depositing each 4-sublayer extrudate 220 printing line 302. Second out-of-plane layer 404 is printed perpendicular to and in contact with first out-of-plane layer 402, with print head 110 moving in the x-direction while depositing 4-sublayer printing line 302 in second out-of-plane layer 404. The additive manufacturing technique yields stimuli-responsive printed objects 116 with out-of-plane (z-axis) layers including in-plane alternating sublayers of first feedstock 212 and second feedstock 214.

A sublayer number along the in-plane (x/y-axis) of 64 sublayers per printing line can help optimize the additive manufacturing technique due at least in part to distinct layer formation and uniform nanoparticle dispersions. The layer number along the out-of-plane (e.g., z-axis) varied from 3 to 10 (e.g., 3L-10L) to test the actuation tunability. Based on this structural design, the actuation mechanism was studied using the shape memory effect (SME) analysis by subjecting the samples to a repeated thermo-mechanical cycle with in-situ dynamic observations. In one example, thermal unbuckling of complex morphologies (e.g., multifold, cylindrical, and helix) and the magnetic rotation of fixed samples also showed stimuli-responsiveness which can be used for broad applications in sensors, actuators, and soft robotics.

### EXAMPLES

Materials. Thermoplastic polyurethane-D (TPU-D) (Ellastollan 1254 D 13 U) and TPU-B (Ellastollan B 60 A 10 WHTSG 000) were provided by BASF, USA. TPU-D is a polyether-based TPU with a reported Shore D hardness of 57, a tensile strength of 60 MPa, and an elongation break of 470%. TPU-D is also resistant to dynamic heat build-up with good hydroelastic stability but loses flexibility at low temperatures. TPU-B is a polyester-based TPU with a Shore A hardness of 60, a tensile strength of ˜25 MPa, and elongation at a break of 900%. TPU-B has heat resistance, shock absorption capability, and chemical resistance and is less affected by cold temperatures. Polycaprolactone (PCL, CAS-No. 24980-41-4) with a molecular number of 80,000 was in the form of pellets and purchased from Millipore Sigma. PCL is a biodegradable polyester with a reported low melting point of ˜60° C. Synthetic black iron oxide (Fe₃O₄>98%) nanoparticles with an average particle size of 300 nm in diameter were purchased from Alpha Chemicals. Phenylbis (2,4,6-trimethyl benzoyl) phosphine oxide (e.g., Irgacure 819 (IR819), 97% assay, CAS-No. 162881-26-7) in the form of powder and dimethylformamide (DMF) (anhydrous, ≥98%) were purchased from Millipore Sigma. All the materials were used as received.

Feedstock Processing and 3D Printing Procedures. Two feedstocks were prepared to form alternating layers within each printing line using the printing apparatus illustrated in FIG. 1. Table 1 provides details of the printing process.

TABLE 1
Nomenclature of the test samples

| | | Compositions | | | | |
|---|---|---|---|---|---|---|
| | | x/y-axis | z-axis | | | |
| Category | Sample | layer # | layer # | Feedstock A | Feedstock B | Rationale |
| 3-layer, | TPU-D | 64 with | 3 | TPU-D/DMF | | Control |
| homogeneous | TPU-B | the | | TPU-B/DMF | | samples to |
| TPU | | sublayer | | | | examine the |
| 3-layer | TPU-D/PCL | domain size | | TPU-D/PCL/DMF | | actuation |
| polymer | TPU-B/Fe₃O₄ | of ~100 μm | | TPU-B/Fe₃O₄/DMF | | conditions |
| mixtures | | | | | | |
| 3- to 10-layer | 3 L | | 3 | TPU-D/PCL/DMF | TPU-B/Fe₃O₄/DMF | PCL as |
| multiphase | 4 L | | 4 | | | phase switch |
| composites | 5 L | | 5 | | | for thermal |
| | 8 L | | 8 | | | actuation |
| | 9 L | | 9 | | | and Fe₃O₄ |
| | 10 L | | 10 | | | for magnetic |
| | | | | | | actuation |

Note:
the post-printing processing was via UV- curing for solidification purposes

Feedstock A included TPU-D and polycaprolactone (PCL) dissolved in DMF. Different weight percentages of TPU-D (e.g., 5 wt %-15 wt %) were added to DMF with constant mechanical stirring at 100° C. After dissolution of TPU-D, varying weight percentages of PCL (e.g., 5 wt %-20 wt %) were added to the TPU-D/DMF solution at the same temperature and stirring speed till complete dissolution. 2 wt % of IR819 was added to the TPU-D/PCL/DMF solution while cooling down to room temperature. This feedstock A was degassed via ultrasonication for 45 min before use.

Feedstock B included TPU-B dissolved in DMF and Fe₃O₄ nanoparticle suspension. The TPU-B (e.g., 55 wt %-65 wt %) was added to DMF with constant mechanical stirring at 100° C. After the dissolution of TPU-B, the Fe₃O₄ (e.g., 7.5 wt %) was suspended in the solution using high-speed mechanical stirring and cooled down to room temperature. 2 wt % of IR819 was added to the TPU-B/Fe₃O₄/DMF solution. This feedstock B was degassed via ultrasonication before use.

Polyurethane-based polymers were chosen due at least in part to an extended- or short-chain polymer network, which is considered favorable for shape memory or fixation effects. The polyurethane biocompatibility may be used in biomedical fields for applications including actuators in soft robotics or regenerative tissue engineering and drug delivery devices. In some examples, polycaprolactone (PCL) is biodegradable and biocompatible in the manufacturing of polyurethanes to modify the mechanical properties of polyurethanes. Fe₃O₄ is used in drug delivery applications due at least in part to availability and cost considerations.

Three different samples were 3D-printed using the additive manufacturing apparatus depicted in FIGS. 1-4, including (i) homogeneous feedstock A or feedstock B including TPU-D/DMF, TPU-B/DMF printed with three layers along the z-axis), (ii) individual mixtures including TPU-D/PCL/DMF, TPU-B/Fe₃O₄/DMF printed with three layers along the z-axis for feedstock A and feedstock B, and (iii) multiphase layers with TPU-D/PCL/DMF as feedstock A and TPU-B/Fe₃O₄/DMF as feedstock B printed with 3-10 layers along the z-axis. All samples had similar printing procedures. For example, one multi-sublayer printing line along the in-plane x/y-axis contained 64 sublayers with a 100 μm domain size for each sublayer, which was observed for all samples. The sublayers along the x/y-axis can evenly distribute the TPU-D/PCL and TPU-B/Fe₃O₄ for thermal and magnetic actuation. In addition, the distribution of Fe₃O₄ can also enhance the mechanical durability of composites. An increase of the layer numbers along the z-axis varied in samples (iii) for different actuating purposes.

3-Layer, Homogeneous TPU. Both syringes were loaded with the same solution (e.g., TPU-D/DMF or TPU-B/DMF) and pumped at a constant flow rate of 1 mL/min. As a result, the homogeneous samples undergo a similar shear process to the composites (TPU-D/PCL & TPU-B/Fe₃O₄ layers) to serve as control samples.

3-Layer Polymer Mixtures. Both the syringes were loaded with the polymer solution mixtures (e.g., TPU-D/PCL/DMF or TPU-B/Fe₃O₄/DMF) and pumped at a constant 1 mL/min flow rate. As a result, the TPU-D/PCL combination responds to temperature, while TPU-B/Fe₃O₄ mixtures respond to the magnetic field.

3-to 10-Layer Multiphase Composites. Feedstock A included TPU-D/PCL/DMF loaded in one syringe, and feedstock B included TPU-B/Fe₃O₄/DMF loaded in the other syringe, pumped at a 1 mL/min flow rate. The layers along the out-of-plane z-axis varied from 3 to 10 layers.

Characterization. The rheology studies were conducted at room temperature (RT) using a cone-and-plate rheometer (Discover Hybrid Rheometer HR2, TA Instruments). The samples were dropped on a 40 mm, 2° Peltier steel cone plate with the viscosity measurement at an increasing strain rate of 0.001-8000 s⁻¹, a truncation gap of 100 μm, and a trim gap of 50 μm. Any excess flow of the sample was cleaned before the test to prevent edge fracture for accurate results. The tensile tests at room temperature and dynamic mechanical analysis (DMA) with the environmental control chamber were conducted using the rectangular tensile setup (Discover Hybrid Rheometer HR2, TA Instruments). A gauge length of 10 mm was set constant for both tests. The tensile tests were conducted on samples until the maximum limit of the machine to find the elastic properties was reached or until a fracture occurred.

The shape memory effect (SME) was tested via the cyclic thermo-mechanical procedures using the DMA. The test was conducted at two different tension strains (250% and 125%), both above the yield point of the samples and potentially causing plastic deformation. The samples with a 10 mm×5 mm×0.18 mm dimension were clamped between the jaws and stretched uniaxially at a constant strain rate of 300 μm/s up to 25 mm (250% strain) and 12.5 mm (125% strain), respectively. After stretching, the samples were frozen at −20° C. using liquid nitrogen for 15-20 minutes to fix the shape inside the environmental chamber. The bottom jaw of the testing setup was unclamped, and the sample was heated to 60° C. in the environmental chamber, with the shape recovery process completed within 2-3 minutes. During each test cycle, the initial length and every subsequent length change in each stretching-freezing-heating-recovering cycle were measured using an in-built digital measuring system of the machine to calculate shape recovery. This process was continuous for a maximum of 15 cycles (until a fracture failure) for each sample to evaluate responsivity and reusability to demonstrate stimuli-responsiveness and shape recovery efficiency.

Analysis by differential scanning calorimetry (DSC) (Discovery DSC 250, TA Instruments) was performed in three cycles (i) heating from −80° C. to 250° C.; (ii) cooling from 250° C. to −80° C., and (iii) heating from −80° C. to 250° C. at a constant rate of 10° C./min in a nitrogen atmosphere. In addition, thermogravimetric analysis (TGA) (Discovery TGA 550, TA Instruments) was conducted for dry and wet samples (water-soaked) to understand the thermal transitions in the air and liquid media. The TGA was performed from RT to 900° C. at a heating rate of 10° C./min in an inert atmosphere using nitrogen.

3D Printing Apparatus. During 3D printing for composite layers, feedstock A (e.g., TPU-D/PCL/DMF) and feedstock B (e.g., TPU-B/Fe₃O₄/DMF) (see chemical compositions in Table 1) were injected from two syringes, respectively. These two syringes were operatively coupled to the same print head to form in-plane layers along either x- or y-axis, as shown in FIGS. 3-4. Thin in-plane layers could distribute different materials at selective locations as desired that may otherwise compromise the printed microstructures or properties. For example, non-compatible materials may form polymer phase separations or particle agglomerations that cause crack propagation and mechanical failures. A uniform nanoparticle distribution (e.g., Fe₃O₄) may contribute to the composite's mechanical, magnetic, and thermal properties. In one example, a one-step alternating deposition of layers from one print head (e.g., a multi-channel print head) would avoid phase mismatches, interfacial debonding, and pore generations in general extrusion-based 3D printing (e.g., FDM). Apart from the materials used as examples in this disclosure, more combinations of materials are possible to provide different stimuli responsiveness.

The printed layers on substrates (e.g., glass) solidified immediately after deposition with in-situ curing (e.g., by means of a 60 W, 405 nm UV source attached below the axil of the print head. FTIR analysis of TPUs with and without photoinitiators display new bond formation due at least in part to cross-linking when exposed to UV light. The layers along the out-of-plane z-axis (layers in the layup) were oriented orthogonal to each other (e.g., 0° and 90°) for producing isotropic properties. In one example, FIG. 2 illustrates printing of one thin ply structure (1L) with an orientation of 0°. FIG. 3 illustrates printing of a second layer with a direction of 90° and shows the 0°/90° stacking with 2 layers (2L) up to 10 layers (10L). As-printed multiphase composites were rapidly printable (e.g., areas as large as 21×21 cm sheet-sized composites containing up to 10 layers along the z-axis were complete within 40 minutes using 70 mL of each feedstock).

Mechanical Characterization. The mechanical properties of the printed samples were obtained through tensile tests to determine the structural integration during actuation conditions. These tested samples included the TPU-B, TPU-B/Fe₃O₄, TPU-D, TPU-D/PCL, and multiphase composite layers of TPU-B/Fe₃O₄— TPU-D/PCL. The chemical compositions of the samples are provided in Table 1. Among them, the TPU-D and TPU-D/PCL fractured with a failure strain of 395% and 440%, respectively, while the rest of the samples were intact at a strain of 475%, showing the elastomer's mechanical robustness with large stretchability. The addition of PCL may act as a functional chain extender to form a crystallized hard segment within the amorphous soft segment of TPU-D. The soft-hard segment mixture may dispose shape fixation with the low melting point (˜60° C.) in PCL to initiate shape recovery and stimuli-responsiveness. A comparison between TPU-B and TPU-B/Fe₃O₄ in the Young's modulus and yield strength tests demonstrates the ability of Fe₃O₄ to contribute to elastic modulus and strength. These mechanical properties also suggest dispersion of the iron oxide particles within the polymer, which may benefit selective particle locations in layers and enable magnetic responsiveness. The multiphase composites (3L) contained TPU-B/Fe₃O₄ and TPU-D/PCL as alternating sublayers within each printed line along the in-plane x/y-axis and 3 layers along the out-of-plane z-axis (0°/90°/0° orientations among z-axis layers). The 3L composites exhibited large deformations (>475%) to ensure structural integrity during actuation and intermediate modulus and strength.

Shape Memory Effect (SME) Analysis. All samples subjected to a cyclic thermo-mechanical analysis were under temperature and force control to determine shape memory effects. The hybrid TPU-D/PCL regions are capable of shape fixing and shape recovery, with the PCL including stiff crystals responsible for shape fixing and temporary shape retention upon stretching, while the TPU-D includes amorphous molecular regions that recover to the original dimensions by releasing the deformation energy upon heating. Applying the uniaxial stress would orient the polymer chains and enable the segmental movement of the molecules with a build-up of elastic strain energy. To prevent the polymer chain from immediate recovery and stabilize the movement of the molecules, freezing the sample below the transition temperature assisted in fixing the shape. When exposed to a temperature near or above the transition temperature, the oriented polymer chain shifted from the glassy to rubbery state, relaxing the molecules to a more thermodynamically stable form. This strain energy release led to the polymer chains' relaxation and subsequent shape recovery. This cyclic thermo-mechanical test used high-tension strains (e.g., 250% and 125%) to examine the shape recovering capability. After each thermo-mechanical cycle, the shape fixity and recovery for N cycles can be calculated as follows,

$$Shape fixity , {R}_{f} = \frac{{ε}_{u} ( N )}{{ε}_{m} ( N )} \qquad ( 1 )$$

$$Shape recovery , {R}_{r} = \frac{{ε}_{u} ( N ) - {ε}_{p} ( N )}{{ε}_{u} ( N ) - {ε}_{p} ( N - 1 )} \qquad ( 2 )$$

where N is the number of cycles, εᵤ is the strain after unloading, εₘ is the strain at maximum load, and εₚ is the final recovered strain. At a strain of 250%, the degree of shape recovery decreased with cycles for all samples. In addition, the TPU-D/PCL deteriorated the most rapidly (e.g., 80% recovery after 5 cycles though the shape fixing ratio stabilized 75%-80%) due at least in part to the rigidness of TPU-D/PCL. TPU-B/Fe₃O₄ and 3L composites displayed ˜85% and 90% recovery, respectively, even after 15 cycles. To produce better recovery capability and actuation responsiveness, the tension strain during the thermo-mechanical analysis was reduced (e.g., 125%). For example, TPU-D/PCL retained the original dimensions before fracturing at a cycle number of 10. The TPU-B/Fe₃O₄ and 3L composites displayed a recovery beyond 95% up to a cycle of 15 due at least in part to a TPU-B/Fe₃O₄ and 3L rubbery state. In one example, TPU-B/Fe₃O₄ showed better recovery but worse shape fixing capability than the TPU-D/PCL, justifying the combination of both compositions in the 3L composites. In one example, the cyclic fatigue tests for 3L composites at room temperature also showed higher elasticity under lower tension strains.

Thermal Analysis. Thermal transitions, including the glass transition (T_{g}), recrystallization point (T_{c}), and melting temperature (Tₘ), are parameters which can be used in the analysis of shape memory effects and thermal actuation conditions. The DSC curves during heating-cooling-heating cycles were measured. Among these samples, PCL pellets showed a Tₘ˜59° C. and T_{c}˜31° C. during the 1^{st} heating and cooling procedures, respectively, while the melting temperature dropped to Tₘ˜57° C. during the 2^{nd} heating. This melting point drop was due at least in part to the molecular reorganization during the 1^{st} melting. In one example, the TPU-D displayed a Tₘ˜170° C., which is a higher melting transition than PCL that could degrade PCL molecule. The degradation can explain the PCL's melting peak appearance in TPU-D/PCL and the disappearance in the cooling/reheating cycles. In one example, the TPU-B sample showed a feature corresponding to a T_{g}˜−50° C. but did not show a feature associate with a melting temperature Tₘ, suggesting the amorphous characteristics may improve thermal stimuli responsiveness.

The crystalline composition of TPU-D/PCL is may provide shape fixation, and TPU-B/Fe₃O₄ may provide shape recoverability. In one example, the actuation efficiency of samples with these sublayer compositions as z-axis layers was analyzed. The transitions of composites with different number of out-of-plane z-axis layers (e.g., 3L, 4L, 5L, 8L, 9L, 10L) were studied. Though small, the melting peaks of PCL remained within a range of 40-50° C. for the 1^{st} heating cycle. The PCL recrystallization during the cooling temperature varied from 60-80° C., implying the confinement of channels within each x/y layer that improved the crystallization upon cooling. In one example, the reheating did not show the PCL melting, possibly due at least in part to degradation with the high heating up to 250° C., which agreed with TPU-D/PCL thermal curves. TPU-B's glass transition of T_{g}˜−50° C. was maintained during the heating-cooling-reheating cycles, suggesting TPU-B's thermal stability provided subsequent actuation behavior without fatigue. In one example, the actuation condition would be in the vicinity of PCL melting peaks (40° C.-65° C.) to avoid PCL degradation and retain TPU glass transition or melting.

To analyze the potential influence of water on the composite structure, TGA curves of the multiphase composite samples (e.g., 3L, 4L, 5L, 8L, 9L, 10L) were measured in dry and wet conditions. In dry conditions, the 10% weight loss of the multiphase composites occurred at ˜250° C., which was also the upper limit temperature for the DSC cycle. Samples were soaked in water for 1 hour to provide wet conditions for the TGA test. Results for the wet conditions showed a more rapid weight loss due at least in part to evaporation of absorbed water than dry samples. After this initial evaporation phase, the weight loss stabilization was similar for both wet and dry samples. This difference in water loss indicated that the moisture content of the environment may influence the mechanical stiffness, thermal transition kinetics, and stimuli responsiveness of the composites.

Thermal Activation via Response Time-Temperature-Layer Number Relationship Studies. All rolled structures with the same dimensions were subjected to the same stimuli-responsiveness experiments to establish the relationship between expansion time(s)−actuation temperature (° C.)−thickness/layer number (e.g., 3L-10L). These samples were 5×5 cm squares and rolled by freezing in the rolled state at −20° C. for 15-20 minutes. The rolling direction was along the diagonal axis (45°) or the x/y-axis (90°). Measurement of the expansion time(s) started with the deposition of rolls in different media (e.g., air and water) and ended with the state of complete unrolling. All layered composites experienced fully unrolled recoveries within the stimulus temperature measurement range of 40-65° C. in air and water. This responsiveness upon heating was consistent with the thermo-mechanical analysis described herein and thermal transition experiments described herein), though the subjected rolling strain was smaller than the SME analyses (<10% in rolling vs. 125% and 150% in DMA tests). In one example, the TPU-D/PCL demonstrated shape fixing (active phase), with PCL acting as the switching element for initiating the actuation upon heating. In one example, TPU-B/Fe₃O₄ demonstrated shape retention effect (passive phase). The maximum rolled strain on the multiphase composites was calculated theoretically (Equation 3) and varied from 3%-10%, respectively, with the increasing thickness (3L to 10L), which was less than the strain used for the SME analysis (125% and 150%). The shape was transitional between a fixed state in rolls upon cooling and an actuation state upon heating in either air or water.

The actuation time increased with decreasing temperature or increasing layer number/sample thickness, both of which affected the bending strain/stress according to the bending theory, given by Equations 3 & 4,

$${ϵ}_{r} = h / 2 r \qquad ( 3 )$$

$${σ}_{r} = My / {h}^{3} \qquad ( 4 )$$

where h is the thickness, r is the rolled inner radius, M is the moment of inertia, and y is the bending modulus. For example, 3L composites rolled at 45° had an expansion time of 45 s and 72 s in the air at a temperature of 65° C. and 40° C., respectively. As a comparison, a larger layer number increased the resistance to similar thermal stress generated in thinner layered structures, showing a response time of ˜140 s, ˜235 s, and ˜260 s for 4L, 8L, and 10L composites, respectively.

The response time increased with decreasing temperature and increasing layer number when the actuation media changed was water. According to the TGA analysis, the water was present in composites after soaking and softening the layers, leading to a lower bending modulus and decreased resistance to thermal stress. In one example, the unrolling time in water decreased compared to the same conditions in air. For example, the same 3L sample discussed above showed an expansion time of 2 s and 17 s in the water at the temperature of 65° C. and 40° C., respectively. The faster response within the water bath environment was also due at least in part to more efficient heat transfer between the actuation objects and water than with air (e.g., the heat convection is more uniform for soaked layers in water). The rolled structures in water at a time of 2 s was observed. The expansion of the 3L sample was observed as the temperature was increased from 40° C. to 65° C.

The rolling direction is another parameter that can be used to control the layer's stimuli-responsiveness. The time in air and water media for samples rolled at 90° versus 45° was studied. The actuation of both 45°-rolled and 90°-rolled composites showed a longer response time with decreasing temperatures and increasing layer numbers in air and water, and a faster responsiveness in water than air for samples of specific layer number and a programmed temperature. The 3L sample in air expands as the temperature was increased from 40° C. to 65° C.

Shape-morphing microrobots have broad applications, including drug delivery in the human body for cancer cell treatment, oil leakage collection, and sewage water treatment. The unrolling procedures for 5-layered (5L) composites also demonstrated stimuli-responsiveness as a function of time for different rolling directions in the air. The complete expansion of the 45°-rolled and 90°-rolled layers took 76 s and 58 s, respectively, to expose and deliver drugs at 60° C., with delivery time programmable by temperature, composite layer, and environmental media. Hotplate-sample thermal conduction was measured after expansion using a thermal imaging camera in the 45°-rolled and 90°-rolled composites. The sample temperatures were lower than the heating source for both conditions, e.g., 35.6° C. and 35.7° C. for 45°-rolled and 90°-rolled composites, respectively, when the hotplate temperature was 40° C. This heat conduction for rolled shells can also be advantageous for expandable objects in space missions (e.g., antenna, rocket shields, and solar panels).

Complex Shape Actuation Demonstration. Exploiting the thermal actuation mechanism and the effects of temperature and sample layers allowed for the design of more complex structures for stimuli-responsiveness purposes. The complex designs included multifold, cylindrical, and helical shapes. Similar to the square samples described above, the complex shapes were frozen at −20° C. for shape fixing for 15-20 minutes before stabilizing. The samples then were subjected to the actuation procedure with a programmed temperature of 60° C. on a hot plate in air medium. The responsiveness depended upon the dimensions and structural complexities of the samples. For example, the multifold origami structure (5×5 cm), with one major fold along the center and two minor folds perpendicular to the primary fold line, expanded from an accordion-like stacking to half-unfolded to fully expanded within 4 minutes. The creases from the folding were present after completion, but the sample was still in condition for multiple fixation-recovery uses. The unrolling of thin tape cylinders 21 cm long with a rolled inner diameter of 2.5 mm was studied. The shape fixing procedure took ˜45 min at a temperature of −20° C. due at least in part to the number of rolls. As a comparison, the actuation on a hotplate at 60° C. took ˜1 min for the sample to start expansion and ˜3 minutes to unroll fully.

The actuation of a helix structure was studied. The dimensions of the helix are as follows: original length of Lₒ=5 cm; wavelength of λₒ=2 cm; and a radius of the cross-section projection on the y-z plane of 2a=5 mm for the projected circle. The 3D helical structure displayed a time-dependence given by Equations 5-7:

$$x ( t , u ) = h t + \frac{R a sin u}{\sqrt{{R}^{2} + {h}^{2}}} \qquad ( 5 )$$

$$y ( t , u ) = R cos ( t ) - a cos t cos u + \frac{h a sin t sin u}{\sqrt{{R}^{2} + {h}^{2}}} \qquad ( 6 )$$

$$z ( t , u ) = R sin ( t ) - a sin t cos u - \frac{h a cos t cos u}{\sqrt{{R}^{2} + {h}^{2}}} \qquad ( 7 )$$

where t is the number of loops, u˜[0, 2π], h is a mathematical constant, R is the radius of the helix, a is the cross-sectional dimension of the helix, and 2πh is the pitch length. An actuation was at 60° C. in the air as observed by the change in the outer radius (R) and the pitch length (R). The actuation of the helical structure was faster than the multifold or rolled cylinders due at least in part to smaller strains. The helix had an actuation time of 25 s. The helix at this actuation time has much longer wavelength than the original structure but does not have a fully actuated shape due at least in part to inefficient thermal contact along with the helix directions.

Magnetic Responsiveness. Iron oxide magnetic nanoparticles have magnetic stability, moderate operating temperature, corrosion resistance, and are relatively inexpensive. In addition, the uniform distribution of Fe₃O₄ nanoparticles within the polymer can enhance mechanical durability, and as a ferromagnetic material, would provide for magnetic responsiveness. As a demonstration of magnetic interactions, a 10L multiphase composite sample was used for fixed-end rotations in air and unrestricted movement on flat surfaces. With a small amount of iron oxide loading (7.5 wt %), the layered composites showed attractions to the magnet and rapid movability. The fixed end rotation of hinge movement of the sample at ˜1 cm/sec was studied. Non-uniform flipping and controlled rolling of the samples following the magnetic field direction was observed. With pre-magnetized attraction and repulsion effects, the iron oxide magnetic nanoparticles in shape-morphing objects can have broad applications, e.g., as a constant agent in magnetic resonance imaging (MRI), targeted drug delivery vehicles, and chemotherapy.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of fabricating a stimuli-responsive object, the method comprising:
providing a first feedstock and a second feedstock to a print head, wherein the first feedstock, the second feedstock, or both comprise one or more stimuli-responsive polymer composites, and the print head comprises n multipliers;
extruding a multi-sublayer extrudate from the print head, wherein the multi-sublayer extrudate comprises 2⁽ⁿ⁺¹⁾/2 sublayers of the first feedstock and 2⁽ⁿ⁺¹⁾/2 sublayers of the second feedstock, and 2⁽ⁿ⁺¹⁾/2−1 sublayers of the first feedstock are in direct contact with two sublayers of the second feedstock;
depositing the multi-sublayer extrudate on a substrate to yield an extrudate layer; and
curing the extrudate layer to yield the stimuli-responsive object.

2. The method of claim 1, wherein the multi-sublayer extrudate comprises 2⁽ⁿ⁺¹⁾ sublayers.

3. The method of claim 1, wherein curing the extrudate layer yields a cured extrudate layer, and further comprising depositing an additional extrudate layer on the cured extrudate layer.

4. The method of claim 3, wherein the additional extrudate layer comprises 2⁽ⁿ⁺¹⁾ sublayers aligned in a direction transverse to 2⁽ⁿ⁺¹⁾ sublayers of the extrudate layer.

5. The method of claim 1, wherein the one or more stimuli-responsive polymer composites comprise thermally actuated polymers.

6. The method of claim 5, wherein the thermally actuated polymers comprise polycaprolactone.

7. The method of claim 1, wherein the one or more stimuli-responsive polymer composites comprise thermoplastic polymers.

8. The method of claim 7, wherein the thermoplastic polymers comprise thermoplastic polyurethane.

9. The method of claim 1, wherein the one or more stimuli-responsive polymer composites comprise magnetic material.

10. The method of claim 9, wherein the magnetic material comprises iron oxide nanoparticles.

11. The method of claim 1, wherein curing the extrudate layer comprises irradiating the extrudate layer with ultraviolet radiation.

12. A stimuli-responsive structure comprising:
two or more sublayers of a first stimuli-responsive polymer composite and two or more sublayers of second stimuli-responsive polymer composite, wherein each sublayer of the first stimuli-responsive polymer composite is in direct contact with at least one sublayer of the second stimuli-responsive polymer composite; and
one or more layers comprising the two or more sublayers of the first stimuli-responsive polymer composite and the two or more sublayers of the second stimuli-responsive polymer composite.

13. The stimuli-responsive structure of claim 12, wherein the first stimuli-responsive polymer composite, the second stimuli-responsive polymer composite, or both comprise thermally actuated polymers.

14. The stimuli-responsive structure of claim 13, wherein the thermally actuated polymers comprise polycaprolactone.

15. The stimuli-responsive structure of claim 12, wherein the first stimuli-responsive polymer composite, the second stimuli-responsive polymer composite, or both comprise thermoplastic polymers.

16. The stimuli-responsive structure of claim 15, wherein the thermoplastic polymers comprise thermoplastic polyurethane.

17. The stimuli-responsive structure of claim 12, wherein the first stimuli-responsive polymer composite, the second stimuli-responsive polymer composite, or both comprise magnetic material.

18. The stimuli-responsive structure of claim 17, wherein the magnetic material comprises iron oxide nanoparticles.
